(19) United States
(12) Patent Application Publication
(10) Pub. No.: US 2024/0139790 A1
(43) Pub. Date: May 2, 2024

(54) COMPOSITE BIOCHAR FOR PREVENTING AND TREATING HEAVY METAL POLLUTION AND PREPARATION METHOD THEREFOR

(71) Applicant: CHINESE RESEARCH ACADEMY OF ENVIRONMENTAL SCIENCES, Beijing (CN)

(72) Inventors: Lei WANG, Beijing (CN); Beidou XI, Beijing (CN); Yangyang WANG, Beijing (CN); Yan SHAO, Beijing (CN); Nan XU, Beijing (CN); Shaofeng LI, Beijing (CN); Xiaoshu WANG, Beijing (CN); Jinsheng WANG, Beijing (CN); Ming CHANG, Beijing (CN); Gen ZHANG, Beijing (CN); Lulu PAN, Beijing (CN); Kui ZHANG, Beijing (CN); Honghu ZENG, Beijing (CN)

(73) Assignee: CHINESE RESEARCH ACADEMY OF ENVIRONMENTAL SCIENCES, Beijing (CN)

(21) Appl. No.: 18/549,904

(22) PCT Filed: Mar. 16, 2022
(86) PCT No.: PCT/CN2022/081180

§ 371 Date: Sep. 9, 2023

(30) Foreign Application Priority Data
Mar. 26, 2021 (CN) 202110328518.8

(51) Int. Cl. B09C 1/10; B09B 3/40; B09B 3/60

(52) U.S. Cl. CPC B09C 1/105; B09B 3/40; B09B 3/60

(57) ABSTRACT

A composite biochar for controlling heavy metal pollution and a process for producing the same, in particular enrichment of heavy metals such as arsenic and lead in soil with centipede grass, thereafter centipede grass is sintered with hydroxyapatite, sepiolite and chitosan, and compounded with microorganisms to produce said composite biochar; through the process of the present invention, heavy metals such as arsenic and lead are stably enriched or coated in said composite biochar, significantly reducing the potential hazard of arsenic and lead to the environment, and also providing new developmental ideas for treating heavy metal biomass.

### TECHNICAL FIELD

The present invention relates to the field of environmental manufacturing technology and specifically relates to a composite biochar for controlling heavy metal pollution.

### BACKGROUND ART

The key factor responsible for heavy metal pollution of soil remains heavy metal waste water produced during production by human activities such as metal smelting industry as well as mining industry. If it is not treated harmlessly, it is discharged directly into nature, heavy metal pollution of water and soil forms. Secondly, heavy metal elements such as lead, arsenic are also present in car exhaust which, although most directly polluting the atmosphere, lead to deposition of such metal pollutants into the soil once subjected to natural settling, rainwater washout, etc. Moreover, some organic fertilizers are produced by the use of municipal waste, channel sludge, and the like, and the raw material itself contains a significant amount of heavy metal elements, which after being applied to the soil results in a significant rise in soil heavy metal content. Soil crops absorb a certain amount of heavy metals and eventually enrich into humans.

Currently, plant remediation technology in soil heavy metal remediation technology utilizes highly enriched plants, planting them in heavy metal contaminated soil, harvesting after ripening, enabling heavy metal removal from contaminated site, is easy to treat and has wide range of applications.

Enrichment of large amounts of heavy metals in polluted sites in plant body, while reducing environmental risk of soil, results in large amounts of polluted biomass that cannot be degraded and thus, potentially secondary pollution of soil and groundwater.

Moreover, since there are differences in adsorption capacities of different plants for heavy metals, thus, in phytoremediation technology, defining which plants can effectively adsorb specific heavy metals, and how the biomass removing the heavy metals is disposed of, is key and challenging to achieve heavy metal reduction and harmless disposal. On the one hand we are to prevent heavy metals from returning to the environment again, and on the other hand we are to explore the potential space for their resource utilization.

For above reasons, there is great need to investigate method for stabilizing heavy metals in biomass and reducing risk of heavy metals to environment.

### SUMMARY OF THE INVENTION

In order to overcome the above problems, the present inventors have conducted research on heavy metal biomass, and provide a composite biochar for controlling heavy metal pollution and a process for producing the same, in particular enrichment of heavy metals such as arsenic and lead in soil with centipede grass, thereafter centipede grass is sintered with hydroxyapatite, sepiolite and chitosan, and compounded with microorganisms to produce said composite biochar. Through the process of the present invention, heavy metals such as arsenic and lead are stably enriched or coated in said composite biochar, significantly reducing the potential hazard of arsenic and lead to the environment, and also providing new developmental ideas for treating heavy metal biomass, thereby completing the present invention.

In particular, it is an object of the present invention to provide a composite biochar for controlling heavy metal pollution, and said composite biochar comprises the following components in parts by weight of:

| | |
|---|---|
| biochar | 50 parts on a dry basis; |
| hydroxyapatite | 10-30 parts; |
| sepiolite | 15-50 parts; |
| chitosan | 5-20 parts. |

Said composite biochar further comprises microorganisms of 60 to 100 volume parts, based on 50 parts by weight of biochar.

Beneficial effects of the present invention include:
(1) The composite biochar provided according to the invention, stable enrichment or coating heavy metals such as arsenic and lead, effectively prolongs the migration time of heavy metals such as arsenic and lead.
(2) The process for producing said composite biochar provided according to the present invention, by adding chicken feces, polyacrylamide and diethylenetriaminepentaacetic acid during the growing of centipede grass, is effective to promote effective absorption or enrichment of heavy metals by centipede grass and to significantly reduce the contents of arsenic and lead in the soil.
(3) The process for producing said composite biochar provided according to the present invention, exploiting the synergistic action of microorganisms, hydroxyapatite, sepiolite and chitosan to increase the stability and decrease the dissolution rate of heavy metal such as arsenic and lead in composite biochar, provides new development ideas for the treatment of heavy metal biomass.

### DETAILED DESCRIPTION OF INVENTION

The present invention will be described in more detail through embodiments and examples. Through these descriptions, the features and advantages of the present invention will become clearer.

The term “exemplary” as used herein is intended to be “serving as an example, an illustrative embodiment, or an embodiment”. Any of the embodiment(s) described herein as “exemplary” need not be construed as preferred as or better than other embodiment(s).

An object of the present invention is to provide a composite biochar for controlling heavy metal pollution, and said composite biochar comprises the following components in parts by weight of:

| | |
|---|---|
| biochar | 50 parts (on a dry basis); |
| hydroxyapatite | 10-30 parts; |
| sepiolite | 15-50 parts; |
| chitosan | 5-20 parts. |

The composite biochar further comprises microorganisms of 60 to 100 volume parts, based on 50 parts by weight of biochar. In particular, when 1 part by weight is 1 g, 1 part by volume is 1 cm 3.

According to the invention, the biochar is enriched with heavy metal elements such as arsenic, lead, complexing the biomass with hydroxyapatite, sepiolite and chitosan is advantageous in stabilizing heavy metal elements in the biochar, effectively reducing the dissolution and migration time of the heavy metal elements.

In the present invention, hydroxyapatite has excellent biocompatibility, bioactivity and ion exchange properties, compounded with biochar containing heavy metal elements, improving stability of the compounded or composite biochar.

According to the invention, sepiolite is a magnesium-rich fibrous silicate clay mineral, in its building block, siloxyl tetrahedra and magnesiloxyl octahedra alternate with each other, with layer-like and chain-like transition-type characteristics. It is due to this unique structure that sepiolite has a high specific surface area, a large porosity, and a good adsorption, rheology and catalysis, which is a desirable additive for stabilizing heavy metal elements.

The present inventors have found that the amino, hydroxyl and carboxyl groups contained in chitosan all have a certain complexing effect on heavy metal ions, long-term stability on heavy metal elements, and after their stabilization the heavy metal ions are present in a more stable, less mobile form.

According to the invention, the microorganisms can donate electrons to reduce the heavy metals, causing an increase in the reduced state of the heavy metals, thereby improving the stability of the composite biochar.

In the present invention, the microorganism is a complex bacterium, the species of which are preferably strong harder arthrobacter and halomonas.

Further, bacterial species were expanded into liquid bacterial species with bacterial concentration of 10⁸-10⁹/mL and mixed to obtain complex bacterial fluid.

In the present invention, the volume ratio of arthrobacter and halomonas is (0.5-3):(1-4), preferably (1-2):(2-3), more preferably 1.5:2.5.

Stability of the composite biochar is optimal in the above parts by weight ranges according to the invention.

In a further preferred embodiment the composite biochar is made from components comprising in parts by weight:

| | |
|---|---|
| biomass | 50 parts (on dry matter basis); |
| hydroxyapatite | 15-20 parts; |
| sepiolite | 20-40 parts; |
| chitosan | 10-15 parts. |

Said composite biochar further comprises microorganisms of 80 to 90 volume parts, based on 50 parts by weight of biochar.

In still further preferred embodiments, the composite biochar comprises components in parts by weight as follows:

| | |
|---|---|
| biomass | 50 parts (on dry matter basis); |
| hydroxyapatite | 16 parts; |
| sepiolite | 25 parts; |
| chitosan | 12 parts; |

Said composite biochar further comprises microorganisms of 88 volume part, based on 50 parts by weight of biochar.

Another aspect of the invention aimed at providing a process for producing composite biochar for controlling heavy metal contamination, and said process comprises:

Step 1, planting a plant in soil containing heavy metals to obtain a biomass enriched with heavy metals.

In step 1, the plant comprises seed plants, bryophytes and ferns, preferably ferns, for example centipede grass, corrugate, bead fern, more preferably centipede grass.

Fern plant spores are large in number, short cycle, strong environmental fitness and barren tolerance according to the invention. Centipede grass in fern plants has unique ecological characteristics of one-time planting, multiple harvesting characteristics, an ultra-enriched plant discovered in recent years with excellent enrichment of heavy metals As and Pb.

According to the invention, said heavy metals comprise As and Pb. Centipede grass grows normally when the concentration of As element in the soil does not exceed 2000 mg/kg and the concentration of Pb element does not exceed 3000 mg/kg, due to the limited absorption capacity of the heavy metals by the plants.

In the present invention, in order to guarantee an effective enrichment of heavy metals As and Pb in the soil by the plant, the concentration of As element in the soil is 500-1000 mg/kg and the concentration of Pb element is 1000-2500 mg/kg. More preferably, the biomass of the plant is maximal, when the concentration of As element in the soil is 800-900 mg/kg and that of Pb element is 1800-2000 mg/kg.

According to the present invention, the addition of an organic matter to the soil where the plant is growing is advantageous to promote the uptake of more heavy metals in the soil by the plant. The adsorption capacity of the heavy metals by the plant is strongest when the organic matter in the soil is present in a ratio of 10-50 wt % of the dry weight of the soil.

Further, the dry weight ratio of organic matter to soil is preferably 20 to wt %, more preferably 25 to 27 wt %.

According to the present invention, the organic material comprises animal faeces such as chicken faeces (or chicken stool), cow faeces, caramel faeces, polymeric polymers such as polyacrylamides, hydroxypropyl methylcellulose, polyacrylic acid amides, chelating agents such as diethylenetriaminepentaacetic acid (DTPA), N-hydroxyethylethylamine triacetic acid (HEDTA), ethylene glycol-bis-(B-aminoethylether)-N, N-tetraacetic acid (EGTA), and the like.

According to the invention, the organic material (or active material) is preferably chicken stool, polyacrylamides and DTPA used together.

In the present invention, there is a difference in the effect of the combination of different kinds of active materials on the enrichment of heavy metals in plants. A mixture of chicken stool, polyacrylamide and DTPA is effective in promoting the enrichment of heavy metals by plants with different aspects of the morphology of the heavy metals, the structure of the soil, and the like.

According to the invention, the chicken stool affects the morphology of heavy metals, increases the organic binding state of the heavy metals such as As and Pb, and promotes the uptake of heavy metals by plants.

In accordance with the present invention, polyacrylamide is effective in improving soil structure, increasing the number of large agglomerates, reducing soil bulk, increasing permeability, increasing soil water content, increasing soil corrosion resistance, and thereby increasing the uptake of heavy metals by plants.

The inventors found that, for polyacrylamide with higher molecular weight, the bridging action between the dispersed soil fines and the action of forming a net at the outer surface of the pellet is stronger, thus the effect in terms of water soil retention is better than polyacrylamide with lower molecular weight. However, if the molecular weight is too high, the molecule does not readily diffuse and convert in the soil layer, therefore the improvement of the depth of the soil layer is limited, and a membranous thin layer of polymeric soil will easily be formed at the soil surface, which in turn weakens the permeability of the soil. Thus, it is preferred that the molecular weight of the polyacrylamide is between 1 and 15 million, preferably between 8 and 12 million, e.g. 10 million.

According to the present invention, DTPA has several chelating sites, and is easily chelated with heavy metal elements.

According to the invention, the weight ratio of chicken stool, polyacrylamide and DTPA is (2-20):(0.1-5):(0.3-2), preferably (5-15):(0.5-3):(0.5-1), more preferably 10:1:0.8, in order to increase soil permeability and plant adsorption capacity for heavy metals.

When used, active materials are mixed in proportions and applied to soil.

In the present invention, plants are used to rich with heavy metals such as As and Pb in soil, and are harvested at 10-50 days of growth, preferably at a growth cycle of 20-30 days, such as 26 days, in order to avoid too long plant growth cycles to cause secondary pollution of the environment.

According to the invention, while plants such as centipede grass can be harvested multiple times once planted, heavy metals are mostly enriched in the roots of the plants and excess enrichment also results in plant death, and therefore, preferably, plants are harvested in their entirety after one cycle of growth thereof.

Further, said plants are harvested, dried, crushed to obtain the biomass.

Wherein the oven drying temperature is 40 to 80° C., preferably 50 to 70° C., more preferably 55° C.; the drying time is 1 to 5 h, preferably 2 to 4 h, more preferably 3 h.

In the present invention, crushed plants are advantageous for coating or enriching heavy metals in the composite biochar during pyrolysis or sintering, thereby enhancing stabilization of the heavy metals. The particle size of crushed plants is between 2 and 20 mm, preferably between 10 and 15 mm, more preferably between 12 and 13 mm.

Step 2, sintering the biomass obtained in step 1 to produce a biochar.

In step 2, said sintered material further comprises hydroxyapatite, sepiolite and chitosan.

In the present invention, since the channels of sepiolite are easily clogged and have poor acid/thermal stability, preferably sepiolite is acidic and thermally modified, in order to unclog the channels, increase the stability of the sepiolite and increase the specific surface of the sepiolite.

Wherein, the acid used in acidic modification is strong acid, which are preferably selected from any one of hydrochloric acid, sulfuric acid, nitric acid, for example sulfuric acid.

According to the invention, upon acidic modification, the dissolution of the carbonates in the sepiolite takes place under the action of the strong acid, the sepiolite structure is thus opened and, at the same time, the water of crystallization in the structure of the sepiolite is removed, therefore achieving the effect of enlarging the specific surface area of the sepiolite. Furthermore, treating the sepiolite with said strong acid also making it possible to increase the thermal resistance of the sepiolite, to modify the pore size distribution and to adjust the internal pore size of the sepiolite.

In the present invention, strong or weak acidity affects the structure and ion exchange capacity of the sepiolite. If the acidity is too weak, weak alkali ions in the sepiolite, such as Mg′, will react with the weak acid to form precipitates, thereby leading to blockage of micropores in the sepiolite structure. If the acidity is too strong, the acid will react excessively with the sepiolite, thereby changing the internal crystal structure of the sepiolite, for example, the micropores will become macropores and the internal specific surface area will be reduced, and furthermore, the reaction of concentrated acids with the sepiolite may generate silica gel, which will reduce the adsorption and ion exchange capacity of the sepiolite.

According to the present invention, the acidic pH is 0 to 5, preferably 1 to 3, more preferably 2.

According to the invention, the acidic modification time is 12 to 48 h, preferably 18 to 36 h, more preferably 24 h.

In the present invention, if the acidic modification time is too short, it is hardly to clog channels of sepiolite, and if the time is too long, it may lead to excessive modification of sepiolite, resulting in change of internal crystal structure of sepiolite.

According to the invention, after the acidic modification is completed, the sepiolite is preferably water-washed, dried, and milled or crushed.

In the present invention, thermal modification may desorb the water of adsorption, the water of crystallization and even the water of hydroxyls in the sepiolite, thereby forming new active surfaces in the internal structure of the sepiolite crystals, reducing the adsorption resistance generated by the water film; furthermore, adsorbing the water within the desorbed sepiolite enables the inner surface of the sepiolite to form large voids, and thus increasing the capacity to store ions and consequent increasing the capacity to absorb metal ions.

According to the invention, the thermal modification temperature is 80 to 250° C., preferably 150 to 200° C., more preferably 180° C.; the thermal modification time is 2 to 6 h, preferably 3 to 5 h, more preferably 4 h.

In the present invention, it is preferable that, before the sepiolite is acidic and thermally modified, the sepiolite is crushed to a particle size of between 10 and 40 mm, preferably between 20 and 30 mm, more preferably between 24 and 25 mm, to provide sufficient pore opening.

Further, the sepiolite obtained from said acidic and thermal modification is ground or crushed to powder.

Since chitosan degrades at high sintering temperatures according to the invention, the biomass is preferably firstly pyrolysed with hydroxyapatite and sepiolite, and then is sintered with chitosan.

In the present invention, to provide sufficient contact between the biomass and hydroxyapatite and sepiolite to improve dispersion uniformity of heavy metals in the biomass, it is preferable hydroxyapatite is formulated into a hydroxyapatite suspension having water content of 40-60%, and the biomass is added thereto, stirred for 3-10 h, and finally sepiolite is added, oven dried after stirring for 5-20 h, and pyrolysed.

Further, hydroxyapatite is formulated into a hydroxyapatite suspension with 45-50% water content, and the biomass is added, stirred for 5-8 h, and finally sepiolite is added, oven dried after stirring for 10-15 h, milled and pyrolysed.

Still further, hydroxyapatite is formulated into a hydroxyapatite suspension with water content of 46%, to which biomass is added, stirred for 7 h, and finally sepiolite is added, oven dried after stirring for 13 h, and pyrolysed.

According to preferred embodiment, in order to thoroughly mix the biomass with hydroxyapatite and sepiolite, hydroxyapatite is preferably comminuted or crushed before mixing to a particle size of 5 to 30 mm, preferably 10 to 20 mm, more preferably 15 to 16 mm.

According to the invention, the pyrolysis is carried out with a stepwise temperature ramp, which comprises the following:

First stage: the pyrolysis temperature is 200-400° C., the heating rate is 8-12° C./min, and the holding time 1-5 h;

Second stage: the pyrolysis temperature is 400-700° C., the heating rate is 7-11® C./min, and the holding time is 0.5-3 h.

In the present invention, as the pyrolysis temperature increases, the specific surface area of the final produced composite biochar is increased, chemical stability is significantly improved, which is favouring coating or enrichment of heavy metal elements. Too high pyrolysis temperature causes the internal structure of the sepiolite or complex biochar to collapse, decreases in specific surface area, ash increases, and the impact is greater on the stability of the composite biochar. The pyrolysis is carried out in stages, which is advantageous to improve the mechanicity of the composite biochar, while the heating rate has the greatest impact on the mechanicity of the composite biochar. Pyrolyzing by the process described above results in the composite biochar being most stable, most mechanically, and most enriched or coated with heavy metal of the composite biochar.

In a further preferred embodiment, the pyrolysis is carried out using a stepwise temperature ramp, which comprises:

First stage: the pyrolysis temperature is 300-350° C., the heating rate is 9-11° C./min, and the holding time is 2-4 h;

Second stage: the pyrolysis temperature is 500-600° C., the heating rate is 8-10° C./min, and the holding time is 1-2 h.

In an even further preferred embodiment, the pyrolysis is carried out using a stepwise temperature ramp as follows:

First stage: the pyrolysis temperature is 320° C., the heating rate is 10° C./min, and the holding time is 2.5 h;

Second stage: the pyrolysis temperature is 550° C., the heating rate is 9° C./min, and the holding time is 1.5 h.

According to the invention, composite biochar made by sintering is poorly compatible when chitosan is directly mixed with the pyrolysis product for sintering. In order to improve the compatibility of chitosan with the pyrolysis product, chitosan is dissolved and mixed with the pyrolysis product and stirred before drying and sintering.

In the present invention, chitosan is insoluble in water, preferably chitosan is dissolved in a weak acid, such as 3% acetic acid, wherein the chitosan is present in 60 to 90%, preferably 70 to 80%, such as 75% by weight of the solution of weak acid.

In the present invention, the stirring time is 2 to 10 h, preferably 5 to 8 h, for example 6 h.

In the present invention, during mixing of the pyrolysis product with the chitosan, the stirring time appears to be particularly important in order to avoid dissolution of the heavy metal in the pyrolysis product due to the weak acidic solvent in which the chitosan is dissolved. The shorter the stirring time, the lower the dissolution rate of the heavy metal. When the stirring time is between 2 and 10 h, the heavy metal does not dissolve and sufficient mixing of the chitosan with the pyrolysis product is ensured.

According to the invention, the sintering temperature is between 80 and 150° C., preferably between 100 and 120° C., more preferably between 110 and 115° C., such as 112° C.

According to the invention, low temperature sintering of chitosan with pyrolysis products can ensure that the structure of the individual molecules in the composite biochar is not disrupted.

According to the invention, in order that the mechanical properties of the composite biochar are not reduced during sintering, the sintering time is 0.5 to 3 h, preferably 1 to 2 h, more preferably 1.5 h; the rate of temperature increase is 2 to 6° C./min, preferably 3 to 5° C./min, more preferably 4° C./min.

Step 3, compounding the biochar produced in step 2 with microorganisms.

The present inventors have found that composite biochar shows higher acceptance and electron donating capacity in a high temperature pyrolysis environment. Microorganisms can donate electrons, reduce heavy metals in the composite biochar and increase stability of heavy metals in the biochar.

In the present invention, the microorganism is a compounded or complex bacterium, the species of which are preferably arthrobacter and halomonas.

Further, bacterial species are expanded into liquid bacterial species with bacterial concentration of 10⁸-10⁹/mL and mixed to obtain complex bacteria.

In the present invention, the volume ratio of arthrobacter and halomonas is (0.5-3):(1-4), preferably (1-2):(2-3), more preferably 1.5:2.5.

### EXAMPLES

The invention is further described below by way of specific examples, which are, however, merely illustrative and do not constitute any limitation on the scope of protection of the invention.

### Example 1

(1) Organic matters (chicken stool, polyacrylamide with a molecular weight of 10 million and diethylenetriamine pentaacetic acid, mixed in the weight rate of 10:1:0.8) at 26% by dry weight of non-contaminated soil, are buried 20 cm into the soil. After 20 days centipede grasses are planted in the soil, and the soil is tilled every 5 days. And then after 7 days, arsenic trichloride and lead nitrate are dissolved with water and deep tilled 15 cm into the soil, which simulating soil enriched with heavy metals, namely As and Pb, wherein the concentrations of As element is 800 mg/kg and that of Pb element is 1800 mg/kg in the simulated soil.

After 26 days centipede grasses are collected and dried at 55° C. for 3 h, and pulverized to a particle size of 12 m to obtain the biomass.

(2) Sepiolite with particle size of 24 mm is shaken in concentrated sulphuric acid with concentration of 1.0 mol/L for 24 h, and the supernatant is poured off, and then is washed 3 times with water, is dried at 90° C., is incubated at 180° C. for 4 h, and is milled until use.

(3) Arthrobacter and halomonas (both purchased from Shanghai Biotech, Inc) are expanded into liquid species at concentration of 10⁸/mL, respectively, and are mixed in liquid volume ratio of 1.5:2.5, to obtain a complex bacteria of arthrobacter and halomonas.

(4) The following parts by weight of components are subjected to the following operations:

| | |
|---|---|
| biomass | 50 parts; |
| hydroxyapatite | 16 parts; |
| sepiolite | 25 parts; |
| chitosan | 12 parts; |

The components further includes 88 parts by volume of complex bacteria of arthrobacter and halomonas prepared in step (3), based on 50 parts by weight of the biomass, wherein 1 part by weight is 1 g and 1 part by volume is 1 cm³. The operations are as follows:

Hydroxyapatite with a particle size of 12 mm is formulated into a hydroxyapatite suspension with water content of 46% and the biomass is added and stirred for 7 h. Thereafter sepiolite is added and oven dried at 80° C. after stirring for 13 h, and then is milled to a powder and pyrolysed according to the following procedure:

First stage: the pyrolysis temperature is 320° C., the heating rate is 10° C./min, and the holding time is 2.5 h;

Second stage: the pyrolysis temperature is 550° C., the heating rate is 9° C./min, and the holding time is 1.5 h.

After pyrolysis, the pyrolysis product is stirred in an acetic acid solution of chitosan (with the solution concentration of chitosan of 75% by weight and that of acetic acid of 3%) for 6 h, oven dried at 60° C., and then is milled and sintered according to the following procedure:

The sintering temperature is 112° C., the heating rate is 4° C./min, and the sintering time is 1.5 h.

The sintered biochar is mixed with the complex bacteria of arthrobacter and halomonas to obtain the composite biochar.

### Example 2

Composite biochar was prepared in a similar manner to Example 1 except that no complex bacteria of arthrobacter and halomonas are added.

### Example 3

Composite biochar was prepared in a similar manner to Example 1 except that no hydroxyapatite, sepiolite, chitosan and composite bacteria of arthrobacter and halomonas are added.

### EXPERIMENTAL EXAMPLES

### Experimental Example 1

Reference “Microwave Digestion Method for Total Soil Heavy Metals (HJ832-2017)”, 0.200 g each of the composite biochar prepared in Examples 1-3 is accurately weighed and placed in a polytetrafluoroethylene digestion tank, respectively, 9 mL of concentrated nitric acid and 3 mL of concentrated HCl are added, allowed to react upon standing for 12 h, and then are put into a microwave digester for digestion, to obtain a digestion liquor. After completion of digestion, the digestion liquor is transferred to a 100 mL volumetric flask, brought to volume up to the mark, shaken well and then passed through a 0.45 μm water-based filtration membrane. The contents of the heavy metals: Pb and As are measured by ICP-OES, converted to the content of the heavy metals in the composite biochar solid, and the results are shown in Table 1:

TABLE 1
total enrichment content of heavy metal

Total Enrichment (mg/g)

| Sample | Pb²⁺ | As³⁺ |
|---|---|---|
| Example 1 | 34 | 19 |
| Example 2 | 32 | 16 |
| Example 3 | 21 | 10 |

### Experimental Example 2

Reference Environmental Protection Standard “Solid Waste Leaching Toxic Leaching Method (HJ 557-2009)”, 0.2 g each of the composite biochar prepared in Examples 1-3 is weighed and placed in a 250 mL Erlenmeyer flask, respectively, 100 mL of deionized water is added. The bottle is closed with parafilm, and the Erlenmeyer flask is placed in a thermostat shaking box and shaken at 25° C. for 8 h with a frequency of 110/min. After completion of the shaking, leaving to stand for 16 h, the supernatant is taken out and brought to a volume of 100 mL, and then passed through a 0.45 μm water-based filtration membrane. The contents of Pb and As elements in the filtrate are measured by ICP-OES, and the results are shown in Table 2:

TABLE 2
Content and dissolution rate of heavy metals in biochar

| | Pb²⁺ | | As³⁺ | |
|---|---|---|---|---|
| | Dissolution | Dissolution | Dissolution | Dissolution |
| | Concentration | Rate | Concentration | Rate |
| Sample | (mg/g) | (%) | (mg/g) | (%) |
| Example 1 | 0.282 | 0.83 | 0.177 | 0.93 |
| Example 2 | 0.422 | 1.32 | 0.174 | 1.09 |
| Example 3 | 1.959 | 9.33 | 0.93 | 9.30 |

### Experimental Example 3

0.200 g each of the composite biochar of Examples 1-3 is weighed and placed in 250 mL Erlenmeyer flask, respectively, and 100 mL of a solution having a pH of 10.0 (adjusted with HCl and NaOH) is added. The Erlenmeyer flasks are placed in a thermostat shaking box and shaken at 25° C. for 8 h with a frequency of 200/min. After shaking is completed, leaving to stand for 16 h, the supernatant is taken out and brought to a volume of 100 mL, and then passed through a 0.45 μm water-based filtration membrane. The contents of Pb and As elements in the filtrate are measured by ICP-OES, and the results are shown in Table 3:

TABLE 3
Content and dissolution rate of heavy metals in biochar

| | Pb²⁺ | | As³⁺ | |
|---|---|---|---|---|
| | Dissolution | Dissolution | Dissolution | Dissolution |
| | Concentration | Rate | Concentration | Rate |
| Sample | (mg/g) | (%) | (mg/g) | (%) |
| Example 1 | 0.312 | 0.92 | 0.213 | 1.12 |
| Example 2 | 0.499 | 1.56 | 0.245 | 1.56 |
| Example 3 | 2.007 | 9.56 | 1.003 | 10.03 |

### Experimental Example 4

0.200 g each of the composite biochar of Examples 1-3 is weighed and placed in a 250 mL Erlenmeyer flask, respectively, and 50 mL of a solution of hydrogen peroxide with a mass concentration of 15% is added respectively. The Erlenmeyer flask is placed in a thermostat shaking box and shaken at 25° C. for 8 h with a frequency of 200/min. After completion of the shaking, leaving to stand for 16 h, the supernatant is taken out and brought to a volume of 100 mL, and then passed through a 0.45 μm water-based filtration membrane. The contents of Pb and As elements in the filtrate are measured by ICP-OES, and the results are shown in Table 4:

TABLE 4
Content and dissolution rate of heavy metals in biochar

| | Pb²⁺ | | As³⁺ | |
|---|---|---|---|---|
| | Dissolution | Dissolution | Dissolution | Dissolution |
| | Concentration | Rate | Concentration | Rate |
| Sample | (mg/g) | (%) | (mg/g) | (%) |
| Example 1 | 0.292 | 0.86 | 0.207 | 1.09 |
| Example 2 | 0.441 | 1.38 | 0.226 | 1.41 |
| Example 3 | 1.934 | 9.21 | 0.987 | 9.87 |

The present invention has been described in detail with reference to preferred embodiments and illustrative examples, but these specific embodiments are only illustrative explanations of the invention, should not be construed as limiting the present invention. Various improvements, substitutions or modifications may be made to the technical disclosure and its embodiments without departing from the spirit and scope of protection of the present invention, all falling within the scope of protection of the invention as set forth in the appended claims.

What is claimed is:

1. A composite biochar for controlling heavy metal pollution, characterized in that,
said composite biochar comprises the following components in parts by weight of:

| | |
|---|---|
| biochar | 50 parts (on a dry basis); |
| hydroxyapatite | 10-30 parts; |
| sepiolite | 15-50 parts; |
| chitosan | 5-20 parts; |

said composite biochar further comprises microorganisms of 60 to 100 volume parts, based on 50 parts by weight of biochar.

2. The composite biochar according to claim 1, characterized in that,
said microorganisms are composite bacteria, preferably arthrobacter and halomonas.

3. A process for producing composite biochar for controlling heavy metal contamination, characterized in that, the process comprises:
step 1, planting a plant in soil containing heavy metals to obtain a biomass enriched with heavy metals;
step 2, sintering the biomass obtained in step 1 to produce a biochar;
step 3, compounding the biochar produced in step 2 with microorganisms.

4. The process according to claim 3, characterized in that,
in step 1, the plant comprises seed plants, bryophytes and ferns, preferably ferns, for example centipede grass, corrugate, bead fern, more preferably centipede grass;
said heavy metals comprise arsenic and lead, and the concentration of arsenic element in soil is no more than 2000 mg/kg, and the concentration of lead element is no more than 3000 mg/kg.

5. The process according to claim 3, characterized in that,
in step 1, an organic matter is added to soil during plant growth, said organic matter including animal faeces, polymeric polymers and/or chelating agents.

6. The process according to claim 3, characterized in that,
in step 2, sintered material further comprises hydroxyapatite, sepiolite and chitosan.

7. The process according to claim 6, characterized in that,
said biomass is pyrolysed with hydroxyapatite and sepiolite, and then is sintered with chitosan.

8. The process according to claim 7, characterized in that,
hydroxyapatite is formulated into a hydroxyapatite suspension with water content of 40-60%, wherein the biomass is added, stirred for 3-10 h, and finally sepiolite is added, stirred for 5-20 h, dried and pyrolysed.

9. The process according to claim 8, characterized in that, the pyrolysis comprises:
first stage: the pyrolysis temperature is 200-400° C., the heating rate is 8-12° C./min, and the holding time is 1-5 h;
second stage: the pyrolysis temperature is 400-700° C., the heating rate is 7-11° C./min, and the holding time is 0.5-3 h.

10. The process according to claim 9, characterized in that,
the sintering temperature is 80-150° C., the heating rate is 2-6° C./min, and the sintering time is 0.5-3 h.
